(19) United States
(12) Patent Application Publication
(10) Pub. No.: US 2008/0168197 A1
(43) Pub. Date: Jul. 10, 2008

(54) PERIPHERAL DEVICE FOR CONNECTION WITH A HOST

(75) Inventors: Tavi SALOMON, Holon (IL); Jonathan Hubert, Los Gatos, CA (US); Jason Patrick Hanlon, Scotts Valley, CA (US); Itzhak Pomerantz, Kfar Saba (IL)

Correspondence Address: MARK M. FRIEDMAN, C/O DISCOVEY DISPATCH , 9003 FLIRIN WAY, UPPER MARLBORO, MD, 20772, US

(73) Assignee: SanDisk IL Ltd., Kfar Saba (IL)

(21) Appl. No.: 11/967,206

(22) Filed: Dec. 30, 2007

Related U.S. Application Data
(60) Provisional application No. 60/885,923, filed on Jan. 22, 2007.
(60) Provisional application No. 60/883,346, filed on Jan. 4, 2007.

(51) Int. Cl. G06F 13/12

(52) U.S. Cl. 710/63

(57) ABSTRACT

A peripheral device for connecting to a host includes a body and a peripheral connector attached to the body. The peripheral connector is connectable to a connector of the host. The peripheral device is configured to facilitate manual attachment to the host and to impede manual detachment from the host. Also provided a peripheral device that includes a body, a first connector connectable to the host connector and a second connector connectable to a connector of an add-on peripheral device; where the body, the first connector and/or the second connector are configured to facilitate manual attachment to the host and to impede manual detachment from the host.

### CROSS-REFERENCE TO EARLIER-FILED APPLICATIONS

This patent application claims priority under 35 U.S.C. § 119(e) to U.S. Provisional Patent Application No. 60/885,923 filed Jan. 22, 2007 and U.S. Provisional Patent Application No. 60/883,346 filed Jan. 4, 2007, which is hereby incorporated by reference in its entirety.

### BACKGROUND OF THE INVENTION

The differing characteristics of portable and embedded devices are well known in the art of computer engineering. The term “portable device” may be used in the art to describe a device that can be plugged and unplugged from a host while the host is operational. The portable device begins operation immediately upon connection to the host. Any risk of damage resulting from multiple connections and disconnections of a portable device is limited to the potential of damaging the content of the portable device. The host is not susceptible to this risk. The ability to connect and to disconnect portable devices while the host is operating is often referred to as a “hot swap”. The term “embedded device” may be used in the art to describe a device that requires powering down the host before the device can be connected to or disconnected from the host. The process of connecting or disconnecting embedded devices requires mechanical intervention, such as unscrewing the case of the computer, so that the host is unlikely to be subjected to a “hot” disconnection. While a portable device can be plugged and unplugged from a host by any user, an embedded device refers to a device that requires a trained technician to unplug the device from the host.

A problem arises when using a device that is physically detachable from a host (i.e. the device is a plug-in into the computer and can be pulled out by any user at any time) but on the other hand the device is involved in processes that should not be interrupted without a proper shut-down procedure. An example is a portable storage device that functions as a cache in a computing system.

FIG. 1 illustrates a prior art portable device, a memory card 10, which is connected with a plug 14 to a standard socket 16 within a recess 22 of a host 11. The standard socket of the host is also referred to herein as the “host connector”. Such connection establishes communication between memory card 10 and host 11. Memory card 10 is long enough so that a portion of its body protrudes from the recess 22 of the host 11.

FIG. 2 illustrates prior art portable devices, each having a form factor of a standard memory card that is connected to the standard socket of the host of FIG. 1. A first memory card 20 and a second (add-on) memory card 24 communicate with the host 11. A plug 26 of the first memory card 20 is connected within a recess 22 to the standard socket 16 of host 11, and plug 30 of the second memory card 24 is connected to a socket 32 of the first memory card 20. Memory card 10 (and also the second memory card 20) is long enough so that a portion of its body protrudes from the recess 22 of the host 11. Thus, no portion of the body of the second memory card 24 enters the recess 22 of the host 11.

Although it is convenient to attach the prior art memory cards of FIGS. 1 and 2 as if they were portable peripheral devices, there is a need to protect these peripheral devices from incidental disconnection like embedded devices. The existing design limits the devices' operation to portable devices only or to embedded devices only.

In view of this prior art and the present needs, it would be desirable to have a peripheral device, which can be conveniently attached to a host but could not be as readily detached from the host.

### SUMMARY OF THE INVENTION

The present invention may be embodied as a peripheral device for connection to a host and optionally also for connection to another (add-on) peripheral device. The peripheral device may implement ExpressCard™ technology. ExpressCard™ technology is a hardware standard that is developed by the Personal Computer Memory Card International Association to enhance the frequency bandwidth of interface and to facilitate the operation and lower the production cost of a system. The ExpressCard™ standard deploys USB 2.0 and PCI-Express as an interface for linking with the system. As the operating system of such technology does not tolerate sudden interruptions in the connectivity between the peripheral device and the host, it is desirable that the peripheral device remains attached to the host connector when the add-on peripheral device is detached from the first peripheral device, rather than having both peripheral devices disconnected from the host connector at the same time. Accordingly, the invention may be embodied such that the peripheral device facilitates manual attachment to the host and impedes manual detachment therefrom.

In one embodiment, a peripheral device includes a body and a peripheral connector that is attached to the body and is connectable to the host connector. At least one of the body and the peripheral connector is configured to facilitate manual attachment of the peripheral device to the host and to impede manual detachment from the host.

The body may have a form factor complying with a standard of an ExpressCard™. The peripheral device may also include flexible arm portions attached to the body. The flexible arm portions may have corresponding hooks that can be engaged with an associated tool.

The peripheral device (i.e. the body and the peripheral connector) may be configured to have a length, which extends in a direction parallel to the direction of inserting the peripheral device into a recess of a host, that is less than or substantially equal to the depth of the recess. The peripheral device may include authentication logic within the body and it may include circuitry providing wireless communication with an external device. Furthermore, the peripheral device may include a storage unit within the body. Moreover, the body may comply with a memory card form factor.

In a second embodiment of the foregoing approach, a peripheral device includes a body, a first connector and a second connector. The first connector is attached to the body and is connectable to the host connector. The second connector is attached to the body and is connectable to the connector of an add-on peripheral device. At least one of the body, the first connector and the second connector is configured to facilitate manual attachment of the peripheral device to the host and to impede manual detachment from the host.

When the first connector is connected to the host connector and the second connector is connected to the connector of the add-on peripheral device, a first connection between the first connector and the host connector may be tighter than a second connection between the second connector and the connector of the add-on peripheral device.

When the first connector is connected to the host connector and the second connector is connected to the connector of the add-on peripheral device, a first force required to detach the peripheral device from the host may be greater than a second force required to detach the add-on peripheral device from the peripheral device. The first connector may be designed such that a first dimension (for example, a width or a depth) of the first connector differs from a corresponding second dimension of the connector of the add-on peripheral device in at least one direction transverse to the direction of inserting the peripheral device into the recess of the host. Optionally or additionally, the second connector may be designed such that a first dimension differs from a corresponding second dimension of the host connector in at least one direction transverse to the direction of inserting the peripheral device into the recess of the host. The peripheral device may have a length extending in a direction parallel to the direction of inserting the peripheral device into the recess of the host, and this length may be set such that it is less than or substantially equal to the depth of the recess.

The peripheral device may include flexible arm portions that are operative to contact adjacent walls of the recess of the host when the add-on peripheral device is connected to the peripheral device. The flexible arm portions may have corresponding hooks that are operative to engage with an associated tool. The peripheral device may also include a storage unit. The body of the peripheral device may comply with a memory card form factor. The peripheral device may also include authentication logic within the body, and circuitry enabling communication with the host. The circuitry may enable wireless communication with an external device.

The body may have a form factor complying with a standard of an ExpressCard™. The peripheral device may include an interface within the body. The interface me be operative to receive from the host signals that have a first transfer rate and other signals that have a second transfer rate, which is greater than the first transfer rate. The interface may also be operative to forward to the add-on peripheral device the signals having the second transfer rate. The first transfer rate may comply with a multi-drop protocol, and that multi-drop protocol may be a USB protocol according to a USB standard. The second transfer rate may comply with a point-to-point protocol, and that point-to-point protocol may be a PCI Express protocol according to a PCI Express standard.

In another embodiment of the foregoing approach, a peripheral device is adapted to connect a card reader to a host. The host has a host connector that includes a USB interface and a PCIe interface, and the card reader is configured to use PCIe signals. The peripheral device may include a first connector, a second connector and an interface. The first connector is connectable to the host connector. The second connector is connectable to a card reader connector. The interface is configured to transfer the PCIe signals between the first connector and the second connector, wherein the peripheral device is compatible with the USB interface.

In another embodiment of the foregoing approach, a peripheral device is connectable to a host. The host has a host connector that includes a USB interface and a PCIe interface. The peripheral device may include a storage portion and a reader portion. The storage portion is operative to communicate with the host at the host connector using the signals that traverse the USB interface; and the reader portion is operative to communicate with the host at the host connector using the signals that traverse the PCIe interface.

In another embodiment of the foregoing approach, a system of peripheral devices for sharing a single host connector is provided. The system may include a peripheral device and an add-on peripheral device. The peripheral device is configured to communicate with the host at the host connector using first signals that comply with a PCIe protocol. The peripheral device may include a first and second peripheral device connectors and a bridge. The first peripheral device connector is connectable to the host connector. The bridge is configured to transfer signals between the first peripheral device connector and the second peripheral device connector. The add-on peripheral device is configured to communicate with the host at the host connector using second signals that comply with a USB protocol and that traverse the bridge of the peripheral device. The add-on peripheral device may include an add-on device connector that is connectable to the second peripheral device connector.

In another embodiment of the foregoing approach, a method of securing connection of a peripheral device and a host includes providing a peripheral device having a body and a connector being connectable to the host; and configuring at least one of the body and the connector to facilitate manual attachment of the peripheral device to the host and to impede manual detachment of the peripheral device from the host. The method may also include controlling the host to communicate with the peripheral device.

In another embodiment of the foregoing approach, a method of securing connection of a peripheral device and a host includes providing a peripheral device having a body, a first connector and a second connector that are attached to the body. The first connector is connectable to a host connector and the second connector is connectable to a connector of an add-on peripheral device. The method also includes configuring at least one of the body, the first connector and the second connector to facilitate manual attachment of the peripheral device to the host and to impede manual detachment of the peripheral device from the host when the add-on peripheral device is being pulled from the second connector.

The configuring may include designing a first connection between the first connector and the host connector to be tighter than a second connection between the second connector and the connector of the add-on peripheral device. The configuring may also include differing at least a first dimension of the first connector from a corresponding second dimension of the connector of the add-on peripheral device in at least one direction transverse to the direction of inserting the peripheral device into the recess of the host. The configuring may also include differing at least a first dimension of the second connector from a corresponding second dimension of the host connector in at least one direction transverse to the direction of inserting the peripheral device into the recess of the host. The configuring may also include designing the body with the first connector and the second connector to have a length extending in a direction parallel to the direction of inserting the peripheral device into the recess of the host to be less than or substantially equal to the depth of a recess of the host.

The configuring may also include attaching flexible arm portions to the body. The flexible arm portions may be operative to contact adjacent walls of a recess of the host when the add-on peripheral device is connected to the peripheral device. Each of the flexible arm portions may also be configured with a hook to engage with an associated tool.

The method may also include receiving from the host signals that have a first transfer rate and signals that have a second transfer rate, which is faster than the first transfer rate; and forwarding to the add-on peripheral device the signals having the second transfer rate.

Additional features, advantages and possible variations of the embodiments described will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding sections or elements throughout, and in which:

FIG. 1 illustrates a prior art memory card connected to a host;

FIG. 2 illustrates two prior art devices, each having a form factor of a standard memory card, that are connected to the host of FIG. 1;

FIG. 3A illustrates a peripheral device in accordance with one embodiment of the present invention;

FIG. 3B is a schematic block diagram illustrating elements within the peripheral device of FIG. 3A;

FIG. 4A illustrates a peripheral device in accordance with a second embodiment;

FIG. 4B is a schematic block diagram illustrating elements within the peripheral device of FIG. 4A;

FIG. 5A illustrates a system of two peripheral devices connected to a host;

FIG. 5B illustrates the relative sizes of connectors in accordance with one embodiment;

FIG. 6 illustrates an embodiment of a tool used for detaching the peripheral device of FIG. 4A from the host;

FIG. 7A illustrates a cross-section of a prior art connector configured according to a standard;

FIG. 7B illustrates a cross-section of a connector configured according to one embodiment; and

FIG. 7C illustrates a cross-sectional connector configuration according to another embodiment.

### DETAILED DESCRIPTION OF THE PREFERRED EMBODIMENTS

The claims below will be better understood by referring to the detailed description of various embodiments of the invention. This description is not intended to limit the scope of claims but instead to provide examples of such embodiments. The embodiments described herein, include a peripheral device for connecting to a host at a host connector, a system for using two peripheral devices in connection to a host at a host connector, and a method of using one or two peripheral devices with a host.

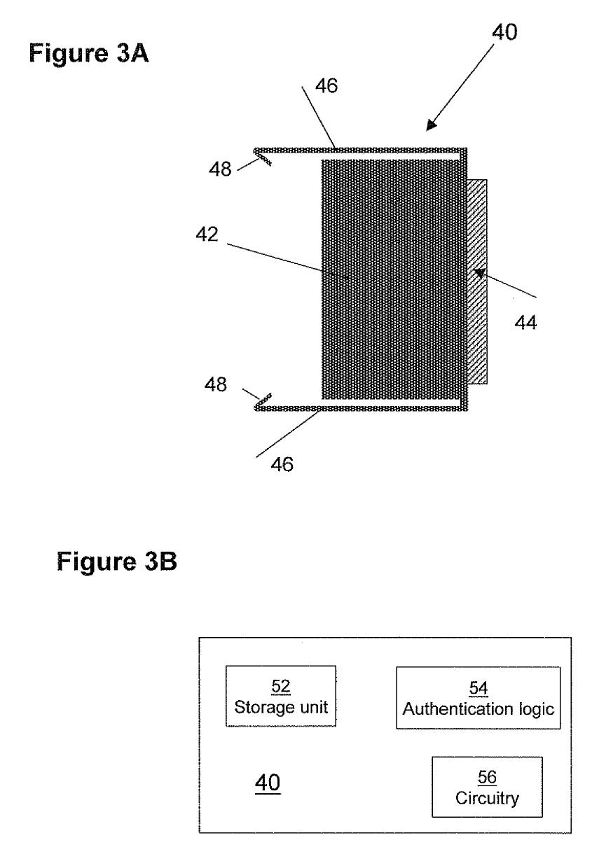

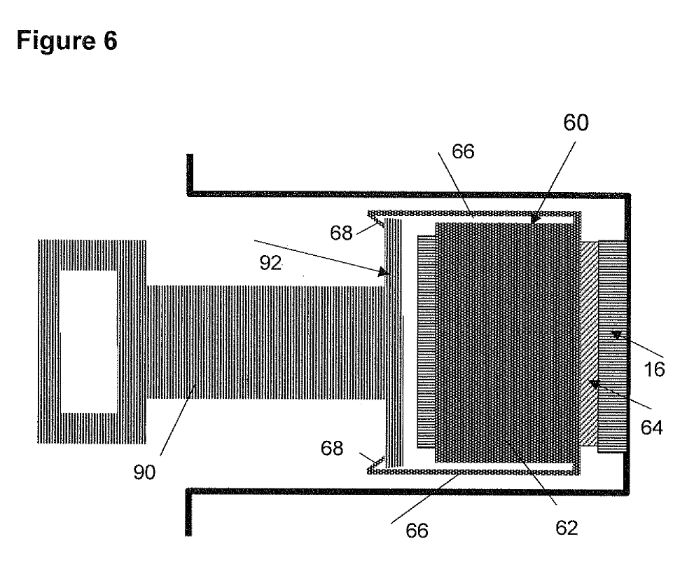

FIG. 3A illustrates one embodiment of a peripheral device 40 for connecting to a host. The peripheral device 40 has a body 42 and a peripheral connector 44 attached thereto. The peripheral connector 44 is connectable to a host connector of a host (see FIG. 6). The peripheral device 40 is configured to facilitate manual attachment to a host and to impede manual detachment from the host. In other words, the peripheral device 40 cannot be detached from the host without using a tool, as explained in more detail below.

That is, the term “manual” is used in the present disclosure to describe the ease of attaching the peripheral device 40 to the host and the difficulty of detaching the peripheral device 40 from the host. (The term “manual” in this context does not mean “not automatic.”) More specifically, by stating that manual attachment is facilitated, the present disclosure references the attribute that no tool or external aid is necessary for a user to attach the peripheral device to the host. The user may connect the peripheral device to the host using his/her bare hands only. Analogously, by stating that manual detachment is impeded, the present disclosure references the attribute that the user cannot detach the peripheral device from the host without the aid of a tool.

Peripheral device 40 may implement ExpressCard™ technology, which accommodates modules designed to comply with either the Universal Serial Bus (USB 2.0) interface standard or the PCI Express (officially abbreviated as PCIe) interface standard. Peripheral connector 44 may be an ExpressCard™ connector. PCIe format is a hybrid serial-parallel interface format that uses multiple connections each of which individually transmits a single stream of data in parallel to another.

The peripheral device 40 is equipped with a pair of flexible arm portions 46 having corresponding hooks 48. The flexible arms 46 are attached to the body 42. By engaging the hooks 48 with an associated tool, a user may detach the peripheral device 40 from the host.

The peripheral device 40 has a length extending in the direction parallel to the direction of inserting the peripheral device 40 into a recess of a host. The length of the peripheral device is less than or substantially equal to the depth of the recess. By “substantially equal,” reference is made to a range of lengths, which include lengths that are enough so that the peripheral device 40 extends slightly from the recess of the host but not far enough for a user to detach the peripheral device 40 from the host manually. That is, the user needs a tool to detach the peripheral device 40 from the host, even if the length of the peripheral device 40 is substantially equal to the recess. With such configuration, the peripheral device 40 is accommodated within the recess of the host, and that manual detachment of the peripheral device 40 from the host connector is impeded. Thus, although the peripheral device 40 may not be long enough to extend out of the recess of its host when connected thereto, thus impeding on a user from gripping the peripheral device 40 with his/her bare hands, peripheral device 40 can be detached from the host if the proper equipment is available. Note that the flexible arms 46 do not extend out of the recess of the host, even if the body 42 does protrude out from the recess. Note also that, instead of having flexible arms as shown in FIG. 3A, embodiments of the peripheral device may have alternate means for securing a connection to the host to facilitate manual attachment to the host and to impede manual detachment from the host.

FIG. 3B shows a schematic block diagram illustrating elements within peripheral device 40 of FIG. 3A. Peripheral device 40 may include a storage unit 52 within the body 42, and peripheral device 40 may further include authentication logic 54 and circuitry 56 within the body 42. Authentication logic 54, which may connect for example to a fingerprint reader, is adapted to authenticate a user's identity. Circuitry 56 supports wireless or wired communication with other peripheral devices. Optionally, the body 42 of peripheral device 40 complies with a memory card form factor.

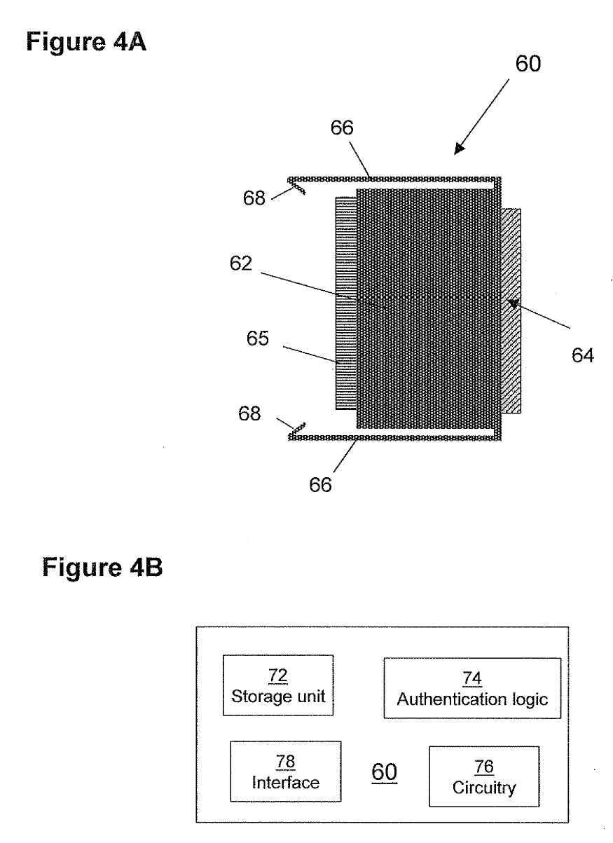

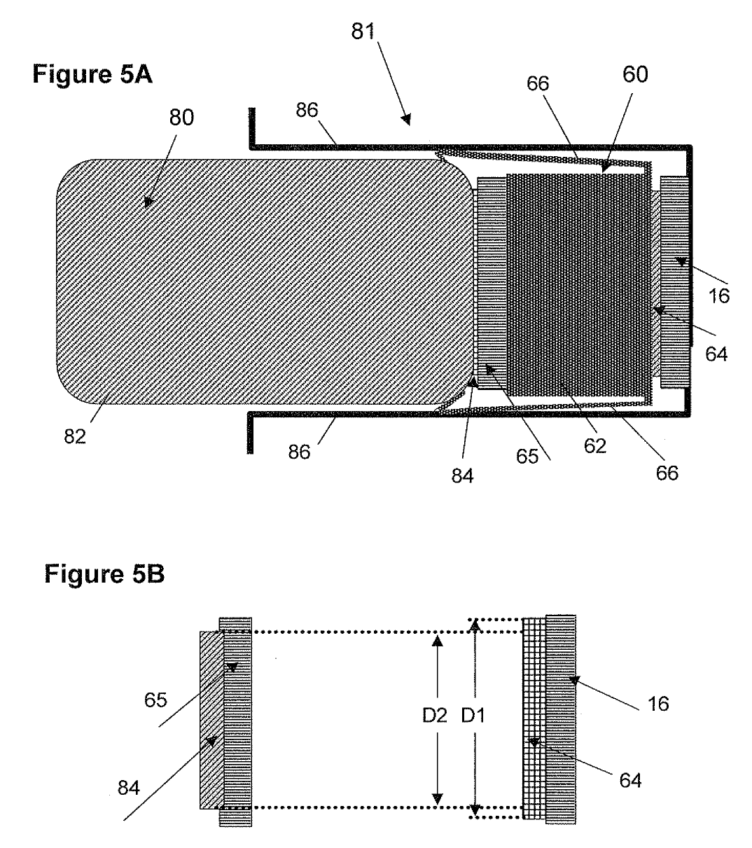

FIG. 4A illustrates a second embodiment of a peripheral device 60 connectable to a host and also connectable to another (add-on) peripheral device (shown in FIG. 5). The peripheral device 60 has a body 62, a first connector 64 and a second connector 65. The first connector 64 is connectable to a host connector. The second connector 65 is connectable to a connector of the add-on peripheral device. The first connector 64 and the second connector 65 are both attached to the body 62. Peripheral device 60 is adapted to facilitate manual attachment to a host and to impede manual detachment from a host. Peripheral device 60 may be an ExpressCard™ and the first connector 64 may be an ExpressCard™ connector.

In some embodiments of the peripheral device, first and second connectors 64, 65 can be designed to have the following effect: when the first connector 64 is connected to the host connector and the second connector 65 is connected to the add-on peripheral device, a first force required to detach the peripheral device 50 from the host may be greater than a second force required to detach the add-on peripheral device from the peripheral device 60. Such design preferably prevents a user from manually pulling the peripheral device 60 from the host when pulling the add-on peripheral device from the host. When the first connector 64 is connected to the host connector and the second connector 65 is connected to the add-on peripheral device, a first connection between the first connector 64 and the host may be tighter than a second connection between the second connector 65 and the connector of the add-on peripheral device.

One way to design the first and second connectors 64, 65 to cause the differing tightness of their connections is to modify the transverse dimensions of at least one of the connectors. As discussed in more detail below, at least one “dimension” (that is, at least one of a width, a depth, or other dimension transverse to the direction of inserting the peripheral device 60 into the host) can be decreased or increased to make a connection tighter or looser.

The peripheral device 60 is configured to have a length (the dimension extending parallel to the direction of inserting the peripheral device 60 into the recess of the host) that is less than or substantially equal to the depth of the recess (see FIG. 5). The design of peripheral device 60 with a reduced length enables the add-on peripheral device (optionally also of a reduced size) to be also contained, at least partly, within the recess of the host when plugged to peripheral device 60. It should be clear that the disclosed embodiments are applicable to any length of an add-on peripheral device.

The peripheral device 60 may be equipped with a pair of flexible arm portions 66, and the flexible arm portions 66 may optionally have corresponding hooks 68. The peripheral device 60 is adapted to facilitate detachment of the peripheral device 60 from the host when the hooks 68 are engaged with an associated tool. This is explained in more detail below with reference to FIG. 6.

FIG. 4B shows a schematic block diagram of elements within peripheral device 60 of FIG. 4A. As shown in FIG. 4B, peripheral device 60 may be configured with an storage unit 72, authentication unit 74 and circuitry 76 supporting wireless or wired communication with other peripheral devices. An interface unit 78 is provided to receive from the host signals that have a first transfer rate and signals that have a second transfer rate, which is faster than the first transfer rate. Interface unit 78 is also operative to forward to an add-on peripheral device (see FIG. 5) the signals having the second transfer rate.

The first transfer rate may comply with a multi-drop protocol, and the second transfer rate may comply with a point-to-point protocol. The term “multi-drop protocol” denotes a communications protocol used when connecting multiple readers to a port concentrator. The multi-drop protocol may be a USB protocol. The term “point-to-point protocol” denotes a line protocol used to connect to remote networking services, including Internet Service Providers. The point-to-point protocol may be a PCI Express protocol. Accordingly, peripheral device 60 is adapted to communicate with the host via a USB protocol or a PCI Express protocol.

FIG. 5A illustrates a system 81 in which two peripheral devices are connected to a host at host connector 16. In FIG. 5A, the first peripheral device is peripheral device 60 of FIG. 4A, and the second peripheral device 80 is an add-on peripheral device having a body 82 and a connector 84 attached to the body 82. Connector 84 is connectable to the second connector 65 of peripheral device 60.

The flexible arm portions 66 of peripheral device 60 are adapted to contact adjacent walls 86 of the recess of the host when the add-on peripheral device 80 is connected to the peripheral device 60. By attaching the add-on peripheral device 80 to peripheral device 60, the body 82 of the add-on peripheral device 80 pushes the flexible arms portions 66 against the adjacent walls 86, causing a strong frictional force between peripheral device 60 and these walls 86. The strong friction created by the flexible arms 66 ensures that peripheral device 60 remains stably plugged into the host when the add-on peripheral device 80 is detached from the host. The flexible arms 66 do not apply any friction force with the walls 86 in the absence of the add-on peripheral device.

Although not necessarily drawn strictly to scale, FIG. 5B illustrates the relative sizes of four connectors. The first connection pair comprises connector 84 of the add-on peripheral device 80 and the second connector 65 of the peripheral device 60. The second connection pair comprises the first connector 64 and the socket 16 of the host. As shown by dotted lines, the first connector 64 is configured to have a dimension D1 (the dimension extending traverse to the direction of inserting the peripheral device 60 into the recess of the host) that is larger than a dimension 12 of the connector 84 of the add-on peripheral device 80. The design of first connector 64 with an increased length tightens its connection with the connector of the host, thus ensuring that the peripheral device 60 is not detached from the host when the add-on peripheral device 80 is detached from the second connector 65 of the peripheral device 60.

FIG. 6 shows an exemplary, non-limiting illustration of a tool 90 used for detaching the peripheral device 60 of FIG. 4A from connector 16 of a host. The external tool 90 has a front bar 92, which engages the hooks 68 of the flexible arm portions 66. Pulling tool 90 away from the host detaches the peripheral device 60 from the connector 16 of the host.

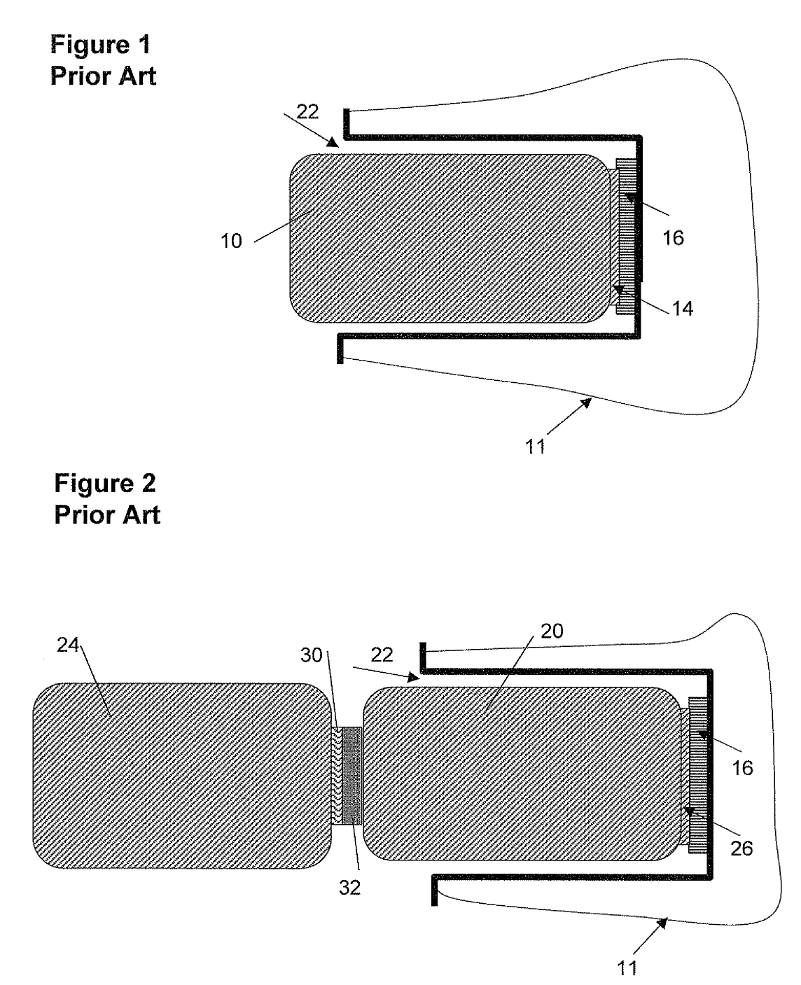

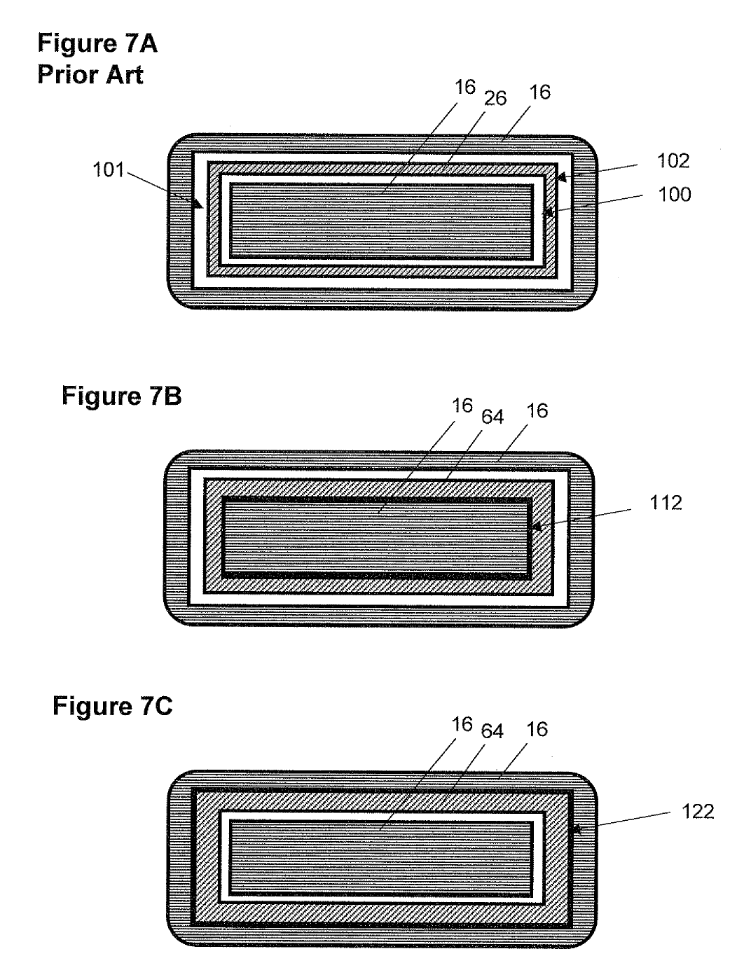

FIG. 7A illustrates a cross-section of a prior art connector configured according to a standard (see for example FIG. 1 and FIG. 2). Plug 26 of the first memory card 20 is plugged into the host connector 16. Plug 26 has diagonal cross-hatching and the host connector 16 has horizontal cross-hatching. Plug 26 is plugged within a recess 101 in the host connector 16. As clearly shown in FIG. 7A, plug 26 includes an internal side 100 and an external side 102.

FIG. 7B illustrates a cross-section of a connector configured according to one embodiment of the present invention, where at least one dimension of the internal side of the first connector 64 is widened inwards (labeled “112”) to make the connection with the host connector 16 tighter than the connector configuration shown in FIG. 7A.

FIG. 7C provides a cross-sectional illustration of a connector configuration according to another embodiment, where at least one dimension of the external side of the first connector 64 is widened outwards (labeled “122”) to make a connection with the host connector 16 tighter than is the connector configuration shown in FIG. 7A.

Note that FIGS. 7A-7C illustrate the external parts of the connection between connector 64 and host connector 16. Thus, the electrical contact between these connectors occurs in the deeper, inner parts of the connection (which is not shown).

The two configurations shown in FIG. 7B and FIG. 7C are provided to make the connection between the peripheral device 60 and the connector of the host tighter than the connection between the add-on peripheral device and the peripheral device 60. The difference between the above two configurations is that in the first one (shown in FIG. 7B), an increased friction is generated between the peripheral device 60 and the connector 16 of the host while in the second configuration (shown in FIG. 7C) the increased friction is generated between the internal and external sides of the first connector 64. In another embodiment, the length of at least one dimension of the second connector 65 of the peripheral device 60 is increased, in order to make the mechanical connection between the add-on peripheral device 80 and the peripheral device 60 looser than the connection between the peripheral device 60 and the connector of the host.

The present invention may also be embodied as a method of using a peripheral device that can not be detached manually from a host. The method may include manually inserting the entire peripheral device into a recess of the host to electrically engage the peripheral device with the host for communication therebetween; and detaching the peripheral device from the host using a tool (note, for example, external tool 90 in FIG. 6). The method may also include manually attaching an ExpressCard™ to the peripheral device after manually inserting the entire peripheral device into the recess of the host and before detaching the peripheral device from the host. The method may also include controlling the host to communicate with the peripheral device after manually inserting the entire peripheral device into the recess of the host and before detaching the peripheral device from the host. The detaching of the peripheral device from the host may be effected by engaging the tool with hooks of flexible arm portions that are attached to the peripheral device.

The present invention may also be embodied as a method of using two peripheral devices with a host. Such method may include manually attaching a first peripheral device to the host; manually attaching a second peripheral device to the first peripheral device; manually detaching the second peripheral device from the first peripheral device without detaching the first peripheral device from the host; and then detaching the first peripheral device from the host using a tool. The first peripheral device is not configured to be manually detached from the host. The method may also include controlling the host to use at least one of the first peripheral device and the second peripheral device after attaching the second peripheral device and before detaching the second peripheral device. The detaching of the first peripheral device may be effected by engaging the tool with hooks of flexible arm portions that are attached to the first peripheral device. Alternatively or additionally, the detaching of the first peripheral device may be effected by using a force greater than the force used to manually detach the second peripheral device from the first peripheral device.

The disclosure above discusses two different types of configuration of a peripheral device. (Note, for example, the peripheral device 40 of FIG. 3A and the peripheral device 60 of FIG. 4A). However, the invention is not limited accordingly. The peripheral device may alternatively be embodied with any other equivalent means for facilitating manual attachment to the host and for impeding manual detachment from the host.

Additional variations of the peripheral device fall within the scope of the invention. For example, a peripheral device may be adapted to connect a card reader to a host, where the host may have a host connector that includes a USB interface and a PCIe interface and the card reader is configured to use PCIe signals. In one embodiment, the peripheral device may include a first connector, a second connector and an interface. The first connector may be connectable to the host connector, the second connector may be connectable to a card reader connector, and the interface may be configured to transfer the PCIe signals between the first connector and the second connector. The peripheral device may be compatible to with the USB interface. In another embodiment, a peripheral device may be connectable to the host, where the host has a host connector that includes a USB interface and a PCIe interface. This peripheral device may include a storage portion that is operative to communicate with the host at the host connector using the signals that traverse the USB interface, and a reader portion that is operative to communicate with the host at the host connector using the signals that traverse the PCIe interface.

The invention may also be embodied as a system of peripheral devices for sharing a single host connector. The system may include a peripheral device and an add-on peripheral device. As an example, the peripheral device and the add-on peripheral device may be the peripheral device and the add-on peripheral device of FIG. 5A correspondingly. The peripheral device may be configured to communicate with the host at the host connector using first signals that comply with a PCIe protocol. The peripheral device may have a first peripheral device connector that is connectable to the host connector, a second peripheral device connector; and a bridge that is configured to transfer signals between the first peripheral device connector and the second peripheral device connector. The add-on peripheral device may be configured to communicate with the host at the host connector using second signals that comply with a USB protocol and that traverse the bridge of the peripheral device. The add-on peripheral device includes a, add-on connector that is connectable to the second peripheral device connector.

The invention may also be embodied as a method of securing connection of a peripheral device and a host. The method may include providing a peripheral device having a body and a connector being connectable to the host; and configuring at least one of the body and the connector to facilitate manual attachment of the peripheral device to the host and to impede manual detachment of the peripheral device from the host. The method may also include providing a peripheral device having a body, a first connector and a second connector that are attached to the body. The first connector may be connectable to a host connector and the second connector may be connectable to a connector of an add-on peripheral device.

Note that the proposed embodiments of the peripheral device are adapted to function with a standard host connector and with a standard connector of an add-on peripheral device. Also note that a “connector” (or “host connector”) is defined in the present invention as any part of a plug-socket pair, serving a host-device pair—whether the part is a male or a female connector, and whether this part is connectable to the host itself or to an external (add-on) device that is connectable to this device.

Having described the foregoing embodiments in detail, it is to be understood that the description is not meant as a limitation, since further modifications will now suggest themselves to those skilled in the art, and it is intended to cover such modifications as fall within the scope of the appended claims.

1. A peripheral device for connecting to a host, the host having a host connector within a recess, the peripheral device comprising:
(a) a body; and
(b) a peripheral connector attached to said body, said peripheral connector being connectable to the host connector;
wherein at least one of said body and said peripheral connector is configured to facilitate manual attachment of the peripheral device to the host and to impede manual detachment of the peripheral device from the host.

2. The peripheral device of claim 1 further comprising:
(c) flexible arm portions that are attached to said body, each of said flexible arm portions having a hook.

3. The peripheral device of claim 1, wherein said body with said peripheral connector have a length extending in a direction parallel to the direction of inserting the peripheral device into the recess of the host, said length being less than or substantially equal to the depth of the recess.

4. The peripheral device of claim 1 further comprising:
(c) a storage unit within said body.

5. The peripheral device of claim 4, wherein said body complies with a memory card form factor.

6. The peripheral device of claim 1, wherein said body has a form factor complying with a standard of an EXPRESSCARD.

7. The peripheral device of claim 1 further comprising:
(c) circuitry enabling wireless communication with an external device.

8. The peripheral device of claim 1 further comprising:
(c) authentication logic within said body.

9. A peripheral device for connecting to a host, the host having a host connector within a recess, the peripheral device comprising:
(a) a body;
(b) a first connector attached to said body, said first connector being connectable to the host connector; and
(c) a second connector attached to said body, said second connector being connectable to the connector of an add-on peripheral device;
wherein at least one of said body, said first connector and said second connector is configured to facilitate manual attachment of the peripheral device to the host and to impede manual detachment of the peripheral device from the host when the add-on peripheral device is being pulled from the second connector.

10. The peripheral device of claim 9, wherein, when said first connector is connected to the host connector and the second connector is connected to the connector of the add-on peripheral device, a first force required to detach the peripheral device from the host is greater than a second force required to detach the add-on peripheral device from the peripheral device.

11. The peripheral device of claim 9, wherein, when said first connector is connected to the host connector and the second connector is connected to the connector of the add-on peripheral device, a first connection between said first connector and the host connector is tighter than a second connection between the second connector and the connector of the add-on peripheral device.

12. The peripheral device of claim 11, wherein at least a first dimension of said first connector differs from a corresponding second dimension of the connector of the add-on peripheral device in at least one direction transverse to the direction of inserting the peripheral device into the recess of the host.

13. The peripheral device of claim 11, wherein at least a first dimension of said second connector differs from a corresponding second dimension of the host connector in at least one direction transverse to the direction of inserting the peripheral device into the recess of the host.

14. The peripheral device of claim 11, wherein said body with said first connector and said second connector have a length extending in a direction parallel to the direction of inserting the peripheral device into the recess of the host, and said length is less than or substantially equal to the depth of the recess.

15. The peripheral device of claim 9, wherein said body has flexible arm portions that are operative to contact adjacent walls of the recess of the host when the add-on peripheral device is connected to the peripheral device.

16. The peripheral device of claim 15, wherein each of said flexible arm portions has a hook that is operative to engage an associated tool.

17. The peripheral device of claim 9 further comprising:
(d) a storage unit within said body.

18. The peripheral device of claim 17, wherein said body complies with a memory card form factor.

19. The peripheral device of claim 9, wherein said body has a form factor complying with a standard of an EXPRESSCARD.

20. The peripheral device of claim 19 further comprising:
(d) an interface within said body, said interface operative to receive from the host signals that have a first transfer rate and signals that have a second transfer rate, which is faster than said first transfer rate, said interface being also operative to forward to the add-on peripheral device said signals having said second transfer rate.

21. The peripheral device of claim 20, wherein said first transfer rate complies with a multi-drop protocol.

22. The peripheral device of claim 21, wherein said multi-drop protocol is a USB protocol according to a USB standard.

23. The peripheral device of claim 20, wherein said second transfer rate complies with a point-to-point protocol.

24. The peripheral device of claim 23, wherein said point-to-point protocol is a PCI Express protocol according to a PCI Express standard.

25. The peripheral device of claim 9 further comprising:
(d) circuitry enabling wireless communication with an external device.

26. The peripheral device of claim 9 further comprising:
(d) authentication logic within said body.

27. A peripheral device adapted to connect a card reader to a host, the host having a host connector that includes a USB interface and a PCIe interface, and the card reader being configured to use PCIe signals, the peripheral device comprising:
(a) a first connector, which is connectable to the host connector;
(b) a second connector, which is connectable to a card reader connector; and
(c) an interface that is configured to transfer the PCIe signals between said first connector and said second connector,
wherein the peripheral device is compatible with the USB interface.

28. A peripheral device connectable to a host, the host having a host connector that includes a USB interface and a PCIe interface, the peripheral device comprising:
(a) a storage portion operative to communicate with the host at the host connector using the signals that traverse the USB interface; and
(b) a reader portion operative to communicate with the host at the host connector using the signals that traverse the PCIe interface.

29. A system of peripheral devices for sharing a single host connector, the system comprising:
(a) a peripheral device configured to communicate with the host at the host connector using first signals that comply with a PCIe protocol, said peripheral device having:
(i) a first peripheral device connector that is connectable to the host connector,
(ii) a second peripheral device connector; and
(iii) a bridge that is configured to transfer signals between said first peripheral device connector and said second peripheral device connector; and
(b) an add-on peripheral device that is configured to communicate with the host at the host connector using second signals that comply with a USB protocol and that traverse said bridge of said peripheral device, said add-on peripheral device having:
(i) an add-on device connector that is connectable to said second peripheral device connector.

30. A method of securing connection of a peripheral device and a host, the method comprising:
(a) providing a peripheral device having a body and a connector being connectable to the host; and
(b) configuring at least one of the body and the connector to facilitate manual attachment of the peripheral device to the host and to impede manual detachment of the peripheral device from the host.

31. The method of claim 31 further comprising:
(c) controlling the host to communicate with the peripheral device.

32. A method of securing connection of a peripheral device and a host, the method comprising:
(a) providing a peripheral device having a body, a first connector attached to the body and a second connector attached to the body, wherein the first connector being connectable to a host connector and the second connector being connectable to a connector of an add-on peripheral device; and
(b) configuring at least one of the body, the first connector and the second connector to facilitate manual attachment of the peripheral device to the host and to impede manual detachment of the peripheral device from the host when the add-on peripheral device is being pulled from the second connector.

33. The method of claim 32, wherein said configuring includes designing a first connection between the first connector and the host connector to be tighter than a second connection between the second connector and the connector of the add-on peripheral device.

34. The method of claim 32, wherein said configuring includes differing at least a first dimension of the first connector from a corresponding second dimension of the connector of the add-on peripheral device in at least one direction transverse to the direction of inserting the peripheral device into the recess of the host.

35. The method of claim 32, wherein said configuring includes differing at least a first dimension of the second connector from a corresponding second dimension of the host connector in at least one direction transverse to the direction of inserting the peripheral device into the recess of the host.

36. The method of claim 32, wherein said configuring includes designing the body with the first connector and the second connector to have a length extending in a direction parallel to the direction of inserting the peripheral device into the recess of the host to be less than or substantially equal to the depth of a recess of the host.

37. The method of claim 32, wherein said configuring includes:
(i) attaching, to the body, flexible aim portions that are operative to contact adjacent walls of a recess of the host when the add-on peripheral device is connected to the peripheral device.

38. The method of claim 37, wherein said configuring further includes:
(ii) configuring each of the flexible arm portions with a hook to engage with an associated tool.

39. The method of claim 32 further comprising:
(c) receive from the host signals that have a first transfer rate and signals that have a second transfer rate, which is faster than said first transfer rate; and
(d) forwarding to the add-on peripheral device the signals having the second transfer rate.
